(19) United States
(12) Patent Application Publication
(10) Pub. No.: US 2025/0064047 A1
(43) Pub. Date: Feb. 27, 2025

(54) Geese Deterrent Device

(71) Applicant: Steven Renne, Jackson, MI (US)

(72) Inventor: Steven Renne, Jackson, MI (US)

(21) Appl. No.: 18/422,294

(22) Filed: Jan. 25, 2024

Related U.S. Application Data
(60) Provisional application No. 63/520,735, filed on Aug. 21, 2023.

(51) Int. Cl. A01M 29/10; G08B 21/18

(52) U.S. Cl. CPC A01M 29/10; G08B 21/18

(57) ABSTRACT

A geese deterrent device is provided. The device is comprised of a motion-activated laser that can be used to deter geese from gathering in a specific area. The device can be secured into a ground surface via an anchoring structure. The laser may be powered by a solar panel in one embodiment. The device may also be comprised of a mobile application that allows a user to configure the laser and view the laser while activated via a camera of the device.

### CROSS-REFERENCE TO RELATED APPLICATION

The present application claims priority to, and the benefit of, U.S. Provisional Application No. 63/520,735, which was filed on Aug. 21, 2023, and is incorporated herein by reference in its entirety.

### FIELD OF THE INVENTION

The present invention relates generally to the field of animal deterrent devices. More specifically, the present invention relates to a geese deterrent device comprised of a motion-activated laser that can be used to deter geese from gathering in a specific area. Accordingly, the present disclosure makes specific reference thereto. Nonetheless, it is to be appreciated that aspects of the present invention are also equally applicable to other like applications, devices, and methods of manufacture.

### BACKGROUND

Geese can often become uninvited guests on various properties, leading to a multitude of problems. Firstly, geese have a tendency to invade lawns, gardens, and other outdoor areas, where they can create significant damage. Their presence often results in the destruction of well-maintained landscapes, as they graze on grass and other plants.

Moreover, one of the most pressing issues with a goose invasion is the accumulation of waste. Geese produce a substantial amount of droppings, which can quickly litter lawns, walkways, and other surfaces. This not only detracts from the aesthetic appeal of the property but also poses health risks. Goose droppings are known to carry a variety of pathogens that can cause diseases in humans. Cleaning and removing this waste can be a strenuous and unpleasant task, often requiring specialized equipment and considerable time.

Another critical concern is the aggressive nature of geese. When geese feel threatened or are approached by humans, they can become surprisingly violent. Geese are equipped with strong beaks and wings, which they use to defend themselves or their territory. This aggressiveness can pose a risk to people, especially children, who might unknowingly provoke them. Consequently, managing the presence of geese in areas frequented by the public can be both challenging and hazardous.

Furthermore, efforts to relocate or encourage geese to move away from certain areas can prove to be both difficult and dangerous. Geese are highly adaptive birds and often return to places they find conducive to their needs. Standard methods of bird deterrence, such as scare tactics or barriers, are often ineffective against geese.

Therefore, there exists a long-felt need in the art for a device that can be used to deter geese from gathering in an area. There also exists a long-felt need in the art for a geese deterrent device. More specifically, there exists a long-felt need in the art for a geese deterrent device that can be used to autonomously deter geese from gathering in an area.

The subject matter disclosed and claimed herein, in one embodiment thereof, comprises a geese deterrent device. The device is comprised of a motion-activated laser that can be used to deter geese from gathering in a specific area. The device can be secured into a ground surface via an anchoring structure. The laser may be powered by a solar panel in one embodiment. The device may also be comprised of a mobile application that allows a user to configure the laser and view the laser while activated via a camera of the device.

In this manner, the geese deterrent device of the present invention accomplishes all the forgoing objectives and provides a geese deterrent device. More specifically, the device can be used to autonomously deter geese from gathering in an area via the motion sensor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a geese deterrent device comprised of a housing with at least one anchoring structure and at least one laser activated by at least one sensor. During use, the device can be secured into a ground surface via the anchoring structure. Then, once the sensor detects movement (preferably of geese) the laser activates to project a laser beam. The projection of the laser beam preferably scares away geese from the area around the device.

The housing is comprised of at least one anchoring structure including but not limited to a ground stake or other pointed/blunt structure of the like. The housing is comprised of at least one sensor that is preferably a motion sensor that detects motion from at least one direction in front of/around the housing. Activation of the sensor (i.e., detection of motion) then activates at least one laser of the device, which projects at least one laser beam onto the area around the device.

In one embodiment, the laser can be rotated/moved via at least one motor in order to allow the laser beam to be more effective in scaring away geese from any area around the device due to increased movement. The laser may move in any movement pattern in different embodiments, such as but not limited to wave or spinning patterns. The device may also be comprised of at least one camera that provides a recording or live video feed of the area around the device.

In one embodiment, the sensor can be turned on via at least one button located on the housing. In a further embodiment, the device is comprised of a mobile application. The mobile application can be installed on a smart device such as but not limited to a computer, a cell phone, a tablet, etc, wherein the smart device is in wireless electrical communication (ex. Wi-Fi, Bluetooth, etc. with the motor, laser, and/or camera via at least one wireless receiver.

The application has a plurality of functions. The application may allow a user to view a live (and/or a recorded) camera feed from the camera. The application may also allow a user to activate the laser (i.e., turn the laser on/off). Further, the application may allow a user to configure the movement pattern of the laser. In addition, the application may alert a user via a call, text, email, app notification, push notification, etc. when the motion sensor has been activated. The application may also allow a user to program the time of day (and/or time period) that the device (i.e., the sensor and/or laser) is active.

The present invention is also comprised of a method of using the device. First, a device is provided comprised of a housing comprised of at least one anchoring structure, at least one sensor, and at least one laser. Then, the anchoring structure can be secured into a ground surface near an outdoor area where an individual wants to prevent geese from gathering. Next, a button of the device can be pressed to activate the laser and/or sensor. As a result, activation of the sensor will activate the laser to project at least one laser beam from the housing into/near the desired area to prevent geese from gathering into said area.

The present invention is also comprised of a second method of using the device. First, a device is provided comprised of a mobile application and a housing comprised of at least one anchoring structure, at least one sensor, at least one receiver, and at least one laser. Then, the anchoring structure can be secured into a ground surface near an outdoor area where an individual wants to prevent geese from gathering. Next, a user can pair a smart device the application is installed on with the receiver. Then, a user can use the application to activate the laser and/or sensor, configure the laser, program a time-period for the device to be active, and view a camera feed from a camera of the device. As a result, activation of the sensor will activate the laser to project at least one laser beam from the housing into/near the desired area to prevent geese from gathering into said area.

Accordingly, the geese deterrent device of the present invention is particularly advantageous as it provides a geese deterrent device. More specifically, the device can be used to autonomously deter geese from gathering in an area via the motion sensor. In this manner, the geese deterrent device provides a solution to autonomously deterring geese from gathering in an area.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a geese deterrent device of the present invention while emitting a laser beam in accordance with the disclosed architecture;

FIG. 2 illustrates a graphical view of functions of a mobile application of one potential embodiment of a geese deterrent device of the present invention in accordance with the disclosed architecture;

FIG. 3 illustrates a flowchart of a method of using one potential embodiment of a geese deterrent device of the present invention in accordance with the disclosed architecture; and

FIG. 4 illustrates a flowchart of a method of using one potential embodiment of a geese deterrent device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to deter geese from gathering in an area. There also exists a long-felt need in the art for a geese deterrent device. More specifically, there exists a long-felt need in the art for a geese deterrent device that can be used to autonomously deter geese from gathering in an area.

The present invention, in one exemplary embodiment, is comprised of a geese deterrent device. The device is comprised of a housing with at least one anchoring structure and at least one laser activated by at least one sensor. During use, the device can be secured into a ground surface via the anchoring structure. Once the sensor detects movement (preferably of geese) the laser activates to project a laser beam. The projection of the laser beam preferably scares away geese from the area around the device.

The housing is comprised of at least one anchoring structure including but not limited to a ground stake or other pointed/blunt structure of the like. The housing is comprised of at least one sensor that is preferably a motion sensor that detects motion from at least one direction in front of/around the housing. Activation of the sensor (i.e., detection of motion) then activates at least one laser of the device, which projects at least one laser beam onto the area around the device.

In one embodiment, the laser can be rotated/moved via at least one motor in order to allow the laser beam to be more effective in scaring away geese from any area around the device due to increased movement. The laser may move in any movement pattern in different embodiments, such as but not limited to wave or spinning patterns. The device may also be comprised of at least one camera that provides a recording or live video feed of the area around the device.

In one embodiment, the sensor can be turned on via at least one button located on the housing. In a further embodiment, the device is comprised of a mobile application. The mobile application can be installed on a smart device such as but not limited to a computer, a cell phone, a tablet, etc, wherein the smart device is in wireless electrical communication (ex. Wi-Fi, Bluetooth, etc. with the motor, laser, and/or camera via at least one wireless receiver.

The application has a plurality of functions. The application may allow a user to view a live (and/or a recorded) camera feed from the camera. The application may also allow a user to activate the laser (i.e., turn the laser on/off). Further, the application may allow a user to configure the movement pattern of the laser. In addition, the application may alert a user via a call, text, email, app notification, push notification, etc. when the motion sensor has been activated. The application may also allow a user to program the time of day (and/or time period) that the device (i.e., the sensor and/or laser) is active.

The present invention is also comprised of a method of using the device. First, a device is provided comprised of a housing comprised of at least one anchoring structure, at least one sensor, and at least one laser. Then, the anchoring structure can be secured into a ground surface near an outdoor area where an individual wants to prevent geese from gathering. Next, a button of the device can be pressed to activate the laser and/or sensor. As a result, activation of the sensor will activate the laser to project at least one laser beam from the housing into/near the desired area to prevent geese from gathering into said area.

The present invention is also comprised of a second method of using the device. First, a device is provided comprised of a mobile application and a housing comprised of at least one anchoring structure, at least one sensor, at least one receiver, and at least one laser. Then, the anchoring structure can be secured into a ground surface near an outdoor area where an individual wants to prevent geese from gathering. Next, a user can pair a smart device the application is installed on with the receiver. Then, a user can use the application to activate the laser and/or sensor, configure the laser, program a time-period for the device to be active, and view a camera feed from a camera of the device. As a result, activation of the sensor will activate the laser to project at least one laser beam from the housing into/near the desired area to prevent geese from gathering into said area.

Accordingly, the geese deterrent device of the present invention is particularly advantageous as it provides a geese deterrent device. More specifically, the device can be used to autonomously deter geese from gathering in an area via the motion sensor. In this manner, the geese deterrent device provides a solution to autonomously deterring geese from gathering in an area.

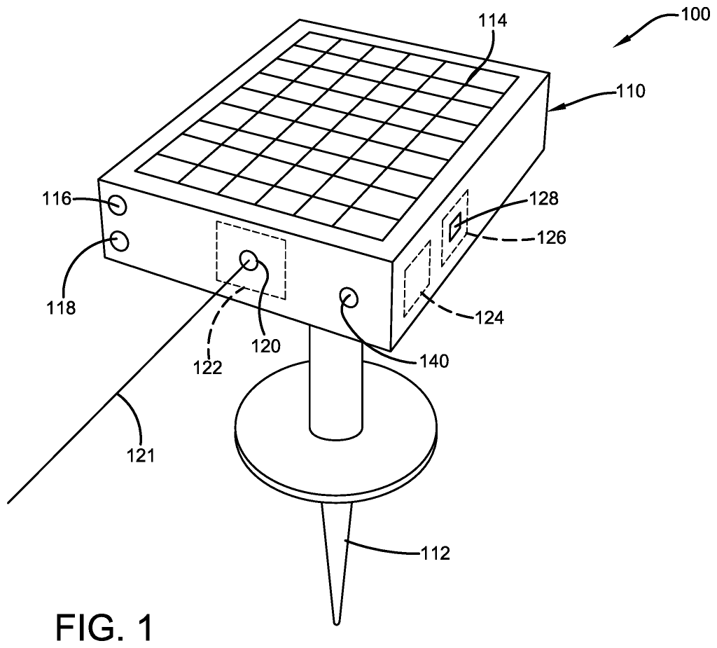

Referring initially to the drawings, FIG. 1 illustrates a perspective view of one potential embodiment of a geese deterrent device 100 of the present invention while emitting a laser beam 121 in accordance with the disclosed architecture. The device 100 is comprised of a housing 110 with at least one anchoring structure 112 and at least one laser 120 activated by at least one sensor 118. During use, the device 100 can be secured into a ground surface via the anchoring structure 112. Then, once the sensor 118 detects movement (preferably of geese) the laser 120 activates to project a laser beam 121. The projection of the laser beam 121 preferably scares away geese from the area around the device 100.

The housing 110 may be any size and shape in different embodiments. The housing 110 is preferably made from a waterproof and UV-resistant material to prevent weather damage (as the device 100 is used outside). The housing 110 is comprised of at least one anchoring structure 112. The structure 112 may be any structure that allows the housing 110 to be driven into a ground surface. This includes but is not limited to a ground stake or other pointed/blunt structure of the like.

The housing 110 is comprised of at least one sensor 118. The sensor 118 is preferably a motion sensor that detects motion from at least one direction in front of/around the housing 110. The field of view of the sensor 118 is preferably between 1 and 360 degrees. Activation of the sensor 118 (i.e., detection of motion) then activates at least one laser 120 of the device 100, which projects at least one laser beam 121 onto the area around the device 100. The laser 120 may be any type of laser. The laser 120 may emit at least one laser beam 121 of any color and pattern. In one embodiment, the laser 120 can be rotated/moved via at least one motor 122 in order to allow the laser beam 121 to be more effective in scaring away geese from any area around the device 100 due to increased movement. The laser 120 may move in any movement pattern in different embodiments, such as but not limited to wave or spinning patterns.

The device 100 may also be comprised of at least one camera 116 that provides a recording or live video feed of the area around the device 100. In one embodiment, the camera 116 is automatically activated when the laser 120 is activated by the sensor 118. The camera 116 may be any camera type known in the art capable of recording pictures or video in day or night conditions.

The camera 116, laser 120, and motor 122 are powered by at least one battery 126 within the housing 110. The battery 126 may be removable or non-removable from the housing 110 in different embodiments. The battery 126 may also be comprised of at least one charging port 128 (of any type) that allows the battery 126 to be recharged in a rechargeable embodiment. In a different embodiment, the battery 126 receives power from at least one solar panel 114 located anywhere on the housing 110.

In one embodiment, the sensor 118 can be turned on via at least one button 140 located on the housing 110. In a further embodiment, the device 100 is comprised of a mobile application 130. The mobile application 130 can be installed on a smart device such as but not limited to a computer, a cell phone, a tablet, etc, wherein the smart device is in wireless electrical communication (ex. Wi-Fi, Bluetooth, etc. with the motor 122, laser 120, and/or camera 116 via at least one wireless receiver 124.

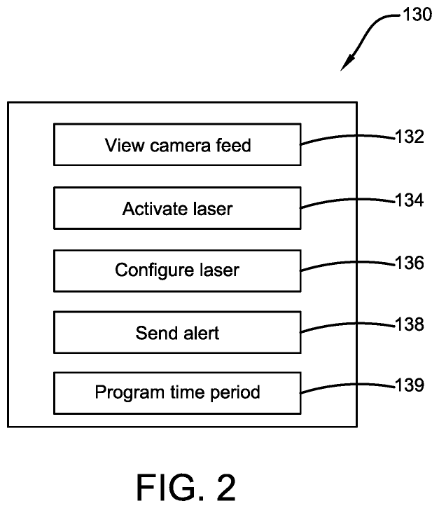

The application 130 has a plurality of functions, as seen in FIG. 2. The application 130 may allow a user to view a live (and/or a recorded) camera feed 132 from the camera 116. The application 130 may also allow a user to activate the laser 134 (i.e., turn the laser on/off). Further, the application 130 may allow a user to configure the movement pattern 136 of the laser 130. In addition, the application 130 may alert a user via a call, text, email, app notification, push notification, etc. when the motion sensor 118 has been activated. The application may also allow a user to program the time of day 139 (and/or time period) that device 100 (i.e., the sensor 118 and/or laser 120) is active.

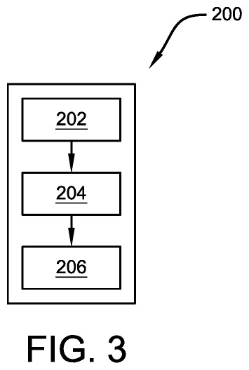

The present invention is also comprised of a method of using 200 the device 100, as seen in FIG. 3. First, a device 100 is provided comprised of a housing 110 comprised of at least one anchoring structure 112, at least one sensor 118, and at least one laser 120 [Step 202]. Then, the anchoring structure 112 can be secured into a ground surface near an outdoor area where an individual wants to prevent geese from gathering [Step 204]. Next, a button 140 of the device 100 can be pressed to activate the laser 120 and/or sensor 118 [Step 206]. As a result, activation of the sensor 118 will activate the laser 120 to project at least one laser beam 121 from the housing 110 into/near the desired area to prevent geese from gathering into said area.

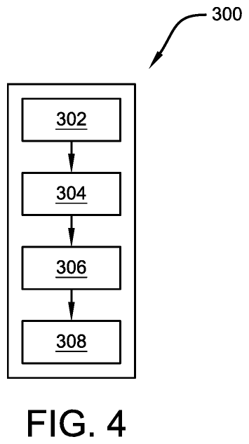

The present invention is also comprised of a second method of using 300 the device 100, as seen in FIG. 4. First, a device 100 is provided comprised of a mobile application 130 and a housing 110 comprised of at least one anchoring structure 112, at least one sensor 118, at least one receiver 124, and at least one laser 120 [Step 302]. Then, the anchoring structure 112 can be secured into a ground surface near an outdoor area where an individual wants to prevent geese from gathering [Step 304]. Next, a user can pair a smart device the application 130 is installed on with the receiver 124 [Step 306]. Then, a user can use the application 130 to activate the laser 120 and/or sensor 118, configure the laser 118, program a time-period for the device 100 to be active, and view a camera feed from a camera 116 of the device 100 [Step 308]. As a result, activation of the sensor 118 will activate the laser 120 to project at least one laser beam 121 from the housing 110 into/near the desired area to prevent geese from gathering into said area.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “geese deterrent device” and “device” are interchangeable and refer to the geese deterrent device 100 of the present invention.

Notwithstanding the forgoing, the geese deterrent device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the geese deterrent device 100 as shown in the FIGS. are for illustrative purposes only, and that many other sizes and shapes of the geese deterrent device 100 are well within the scope of the present disclosure. Although the dimensions of the geese deterrent device 100 are important design parameters for user convenience, the geese deterrent device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A geese deterrent device comprising:
a housing comprised of an anchoring structure;
a sensor;
a laser activated by activation of the sensor;
a battery; and
a button.

2. The geese deterrent device of claim 1 further comprised of a solar panel.

3. The geese deterrent device of claim 1, wherein the anchoring structure is comprised of a pointed structure.

4. The geese deterrent device of claim 1, wherein the housing is comprised of a waterproof material.

5. The geese deterrent device of claim 1, wherein the housing is comprised of a UV-resistant material.

6. The geese deterrent device of claim 1, wherein the laser produces a laser beam.

7. The geese deterrent device of claim 6, wherein the laser beam is comprised of a color.

8. The geese deterrent device of claim 1, wherein the battery is comprised of a charging port.

9. A geese deterrent device comprising:
a housing comprised of an anchoring structure;
a sensor;
a motor;
a camera;
a laser activated by activation of the sensor;
a battery; and
a button.

10. The geese deterrent device of claim 9 further comprised of a solar panel.

11. The geese deterrent device of claim 9, wherein the anchoring structure is comprised of a pointed structure.

12. The geese deterrent device of claim 9, wherein the laser beam moves in a pattern via the motor.

13. The geese deterrent device of claim 9 further comprised of a receiver.

14. The geese deterrent device of claim 9 further comprised of a mobile application.

15. The geese deterrent device of claim 13, wherein the mobile application allows a user to view a live feed from the camera or a recording from the camera.

16. The geese deterrent device of claim 13, wherein the mobile application allows a user to turn the laser on and off.

17. The geese deterrent device of claim 13, wherein the mobile application alerts a user when the sensor has been activated.

18. A method of using a geese deterrent device, the method comprising the following steps:
providing a geese deterrent device comprised of a housing comprised of an anchoring structure, a sensor, and a laser;
securing the anchoring structure into a ground surface; and
activating the sensor.

19. The method of using a geese deterrent device of claim 18, wherein the geese deterrent device is comprised of a motor.

20. The method of using a geese deterrent device of claim 18, wherein the geese deterrent device is comprised of a mobile application.
